(19) United States
(12) Patent Application Publication
(10) Pub. No.: US 2015/0202814 A1
(43) Pub. Date: Jul. 23, 2015

(54) CONTROLLER FOR INJECTION MOLDING MACHINE HAVING FUNCTION OF REDUCING SYNCHRONOUS ERRORS

(71) Applicant: FANUC Corporation, Yamanashi (JP)

(72) Inventor: Junpei MARUYAMA, Yamanashi (JP)

(21) Appl. No.: 14/598,465

(22) Filed: Jan. 16, 2015

(30) Foreign Application Priority Data
Jan. 20, 2014 (JP) 2014-007810

(51) Int. Cl. B29C 45/77

(52) U.S. Cl. CPC B29C 45/77

(57) ABSTRACT

A controller for an injection molding machine is provided with a pressure control unit configured to calculate speed command values for a plurality of injection motors, a synchronous error detection unit configured to detect a synchronous error in position between the injection motors, a synchronous error correction unit configured to calculate a correction amount for a speed command value as a synchronous-error-correction manipulated variable for reducing the synchronous error, and a speed control unit configured to control the speeds of the injection motors based on a post-correction speed command value obtained by correcting the calculated speed command value from the pressure control unit by the synchronous error correction unit.

### BACKGROUND OF THE INVENTION

1. Field of the Invention

The present invention relates to a controller for an injection molding machine, and more particularly, to a controller for an injection molding machine having a function of reducing synchronous errors.

2. Description of the Related Art

Some known injection molding machines use servomotors as axis drive mechanisms. In many of small-sized injection molding machines, each one servomotor is provided for driving each of driven members, such as an injection unit, mold clamping unit, etc. In the case of a large injection molding machine, which requires a great axis driving force, however, a plurality of servomotors are provided for driving a single driven member. For example, Japanese Patent Application Laid-Open No. 2003-189657 discloses a technique for maintaining positional synchronization between a plurality of servomotors. According to this technique, the servomotors are individually provided with position control units, to which the same position command is issued to maintain the positional synchronization between the servomotors.

Japanese Patent Applications Laid-Open Nos. 2002-079556 and 2003-200469 disclose a technique in which current commands for a plurality of injection motors are calculated as pressure-control manipulated variables for coincidence between a detected pressure and a set pressure and the calculated current commands are corrected to reduce the difference in position or applied pressure between the injection motors. Japanese Patent Application Laid-Open No. 2004-195926 discloses a technique in which a screw movement command is calculated based on the difference between an injection pressure command and an actual injection pressure and a plurality of motors are individually drivingly controlled by position controllers based on the calculated screw movement command.

In the technique disclosed in Japanese Patent Applications Laid-Open Nos. 2002-079556 and 2003-200469, the current commands are calculated as the pressure-control manipulated variables, so that there is a possibility of the response speed of pressure control being reduced. Since the current commands are corrected to reduce the difference in position between the injection motors, moreover, the necessary response for the reduction of the difference in position may possibly be delayed.

In the technique disclosed in Japanese Patent Application Laid-Open No. 2004-195926, the motors are controlled by their respective position controllers, so that the difference in position between the motors can be reduced by issuing the same screw movement command to the position controllers. Since the screw movement command is calculated as a manipulated variable for pressure control, however, there is a possibility of the response speed of the pressure control being reduced.

### SUMMARY OF THE INVENTION

Accordingly, an object of the present invention is to provide a controller for an injection molding machine, capable of improving the response characteristics of pressure during pressure control and reducing synchronous errors in position and speed between axes. Another object of the present invention is to provide a controller for an injection molding machine, furnished with a physical quantity detection unit for detecting a clamping force, moving platen position, mold opening amount, etc., in place of a pressure control unit, and capable of improving the response characteristics of physical quantities and reducing synchronous errors in position and speed between axes, even when a plurality of motors are controlled so that the detected physical quantities are equal to set values.

A controller for an injection molding machine according to the present invention is configured so that one driven member of the injection molding machine is driven by a plurality of axes and comprises a physical quantity detection unit configured to detect one of physical quantities including an injection pressure, clamping force, moving platen position, and mold opening amount, which are controlled by the driven member, a speed command calculation unit configured to calculate a speed command value based on a deviation between the detected physical quantity and a command value, a synchronous error detection unit configured to detect a synchronous error between the axes, speed control units arranged in one-to-one correspondence with the axes, and a synchronous error correction unit configured to correct the speed command value based on the detected synchronous error for each of the axes, the speed control units being configured to calculate a torque command or a current command based on the corrected speed command value and a detected speed.

The synchronous error correction unit may be configured to correct speed command values for all the axes including a single master axis or slave axes or all the other axes than the master axis.

The synchronous error detection unit may be configured to detect the synchronous error based on the difference between the positions of the master axis and the other or slave axes, between an average position of all the axes and the position of each of the axes, or the difference between the position of each of the axes and an average position of all the other axes.

The synchronous error correction unit may be configured to correct the speed command value with respect to an advancing direction to increase for that one of the axes whose movement is delayed with respect to that of the other axes and/or corrects the speed command value with respect to the advancing direction to be reduced for that one of the axes whose movement is advanced with respect to that of the other axes.

The driven member may be an injection screw, the axes for driving the driven member may be injection axes, and the physical quantity may be an injection pressure. Alternatively, the driven member may be a moving platen, the axes for driving the driven member may be clamping axes, and the physical quantity may be a clamping force, moving platen position, or mold opening amount.

According to the present invention arranged as described above, there can be provided a controller for an injection molding machine, capable of improving the response characteristics of pressure during pressure control and reducing synchronous errors in position and speed between axes. Further, there can be provided a controller for an injection molding machine, furnished with a physical quantity detection unit and capable of improving the response characteristics of physical quantities and reducing synchronous errors in position and speed between axes, even when a plurality of motors are controlled so that the detected physical quantities are equal to set values.

### BRIEF DESCRIPTION OF THE DRAWINGS

The above and other objects and features of the present invention will be obvious from the ensuing description of embodiments with reference to the accompanying drawings, in which:

FIG. 1 is a diagram showing an embodiment in which a speed command value for a slave axis is corrected;

FIG. 2 is a diagram showing an embodiment in which speed command values for master and slave axes are corrected;

FIG. 3 is a diagram showing an embodiment in which a single driven member is driven by three axes; and

FIG. 4 is a diagram showing an embodiment in which a synchronous error is detected and corrected based on a speed difference in place of a position difference.

### DETAILED DESCRIPTION OF THE PREFERRED EMBODIMENTS

A controller for an injection molding machine according to an embodiment of the present invention comprises a pressure control unit configured to calculate speed command values for a plurality of injection motors, as pressure-control manipulated variables for coincidence between a set pressure and a pressure detected by a pressure sensor 71 attached to the proximal portion of an injection screw 72, a synchronous error detection unit configured to detect a synchronous error in position between the injection motors, a synchronous error correction unit configured to calculate a correction amount for a speed command value as a synchronous-error-correction manipulated variable for reducing the synchronous error, and a speed control unit configured to control the speeds of the injection motors based on a post-correction speed command value obtained by correcting the calculated speed command value from the pressure control unit by the synchronous error correction unit.

### Embodiment 1

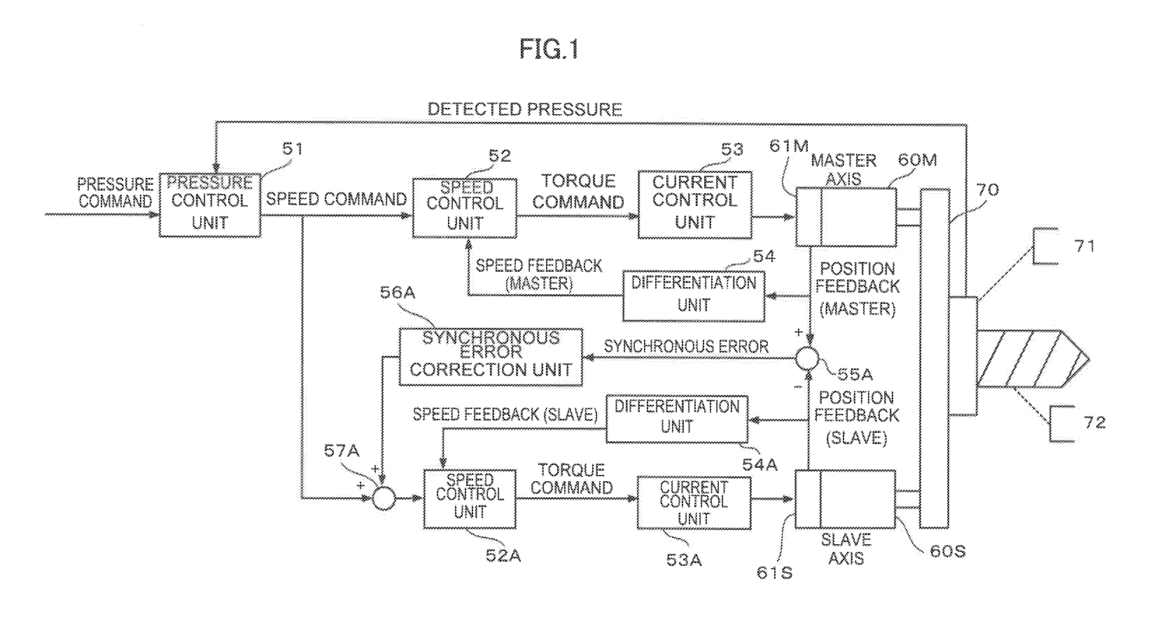

FIG. 1 is a diagram showing an embodiment in which a speed command value for a slave axis is corrected. A controller for controlling motors for a master axis 60M and a slave axis 60S comprises a pressure control unit 51, speed control units 52 and 52A, current control units 53 and 53A, differentiation units 54 and 54A, a synchronous error detection unit 55A, and a synchronous error correction unit 56A. The pressure control unit 51 receives a pressure command output from a host control unit. Position sensors 61M and 61S for detecting the rotational positions of the motors are built in the motors for the master and slave axes 60M and 60S, respectively. The motors for the master and slave axes 60M and 60S convert rotary drive to linear drive by means of ball screws and nuts, thereby advancing and retracting a slide plate 70. The slide plate 70 is fitted with the proximal portion of an injection screw 72 with a pressure sensor 71 therebetween.

The pressure control unit 51 calculates a speed command corresponding to a pressure deviation, based on the difference between a pressure command and a pressure detected by the pressure sensor 71, and outputs the calculated speed command to the speed control unit 52 and an adder 57A.

The speed control unit 52 calculates a torque command corresponding to a speed deviation, based on the difference between the speed command output from the pressure control unit 51 and a speed feedback of the motor for the master axis 60M from the differentiation unit 54, and outputs the calculated torque command to the current control unit 53. The speed control unit 52A calculates a torque command corresponding to the speed deviation, based on the difference between a speed command, which is obtained by adding the value output from the pressure control unit 51 and a correction value output from the synchronous error correction unit 56A by the adder 57A, and a speed feedback of the motor for the slave axis 60S from the differentiation unit 54A, and outputs the calculated torque command to the current control unit 53A.

The current control unit 53 receives the torque command output from the speed control unit 52 and supplies a current to the motor for the master axis 60M in response to the input torque command. The current control unit 53A receives the torque command output from the speed control unit 52A and supplies a current to the motor for the slave axis 60S in response to the input torque command.

The differentiation unit 54 differentiates the position feedback from the motor for the master axis 60M and feeds it back as a speed feedback to the speed control unit 52. Further, the differentiation unit 54A differentiates the position feedback from the motor for the slave axis 60S and feeds it back as a speed feedback to the speed control unit 52A.

The synchronous error detection unit 55A calculates and outputs, as a synchronous error, the difference between the position feedback from the motor for the master axis 60M and the position feedback from the motor for the slave axis 60S. The synchronous error output from the synchronous error detection unit 55A is input to the synchronous error correction unit 56A. The synchronous error correction unit 56A calculates a correction amount for a speed command corresponding to the synchronous error input from the synchronous error detection unit 55A and outputs it to the adder 57A.

### Embodiment 2

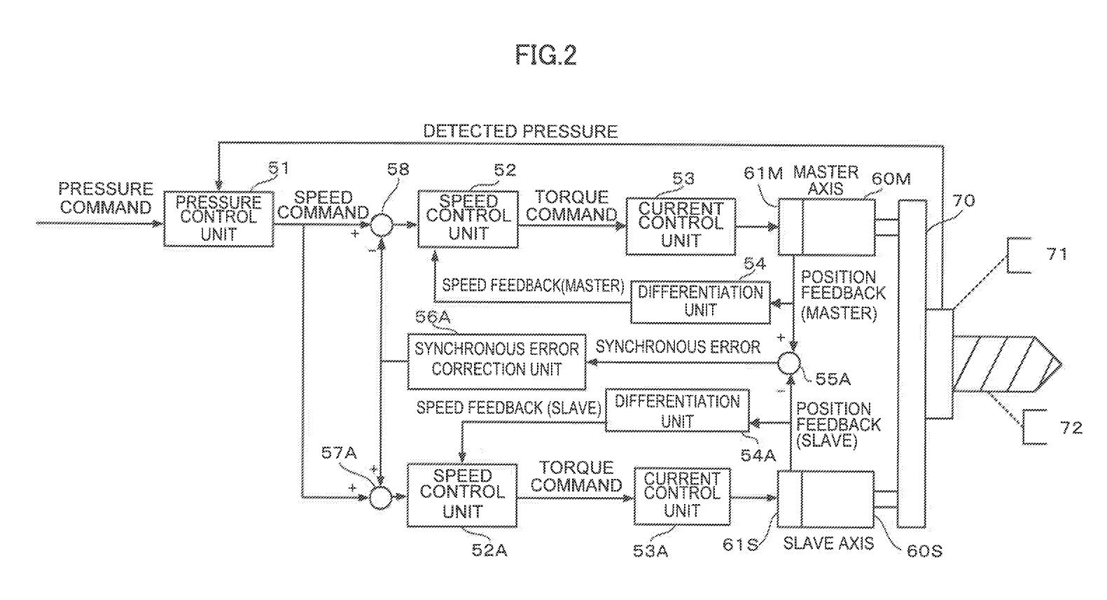

FIG. 2 is a diagram showing an embodiment in which speed command values for master and slave axes are corrected. A controller for controlling motors for a master axis 60M and a slave axis 60S comprises a pressure control unit 51, speed control units 52 and 52A, current control units 53 and 53A, differentiation units 54 and 54A, a synchronous error detection unit 55A, and a synchronous error correction unit 56A. The pressure control unit 51 receives a pressure command output from a host control unit.

The pressure control unit 51 calculates a speed command corresponding to a pressure deviation, based on the difference between a pressure command and a pressure detected by the pressure sensor 71, and outputs the calculated speed command to a subtracter 58 and the adder 57A. The subtracter 58 subtracts a correction value output from the synchronous error correction unit 56A from the speed command output from the pressure control unit 51, and outputs the result of the subtraction to the speed control unit 52. The adder 57A adds the speed command output from the pressure control unit 51 and the correction value output from the synchronous error correction unit 56A, and outputs the result of the addition to the speed control unit 52A.

The speed control units 52 and 52A, current control units 53 and 53A, and differentiation units 54 and 54A are constructed in the same manner as those of the Embodiment 1.

The synchronous error detection unit 55A calculates and outputs, as a synchronous error, the difference between the position feedback from the motor for the master axis 60M and the position feedback from the motor for the slave axis 60S. The synchronous error output from the synchronous error detection unit 55A is input to the synchronous error correction unit 56A. The synchronous error correction unit 56A calculates a correction amount for a speed command corresponding to the synchronous error input from the synchronous error detection unit 55A and outputs it to the adder 57A and the subtracter 58.

### Embodiment 3

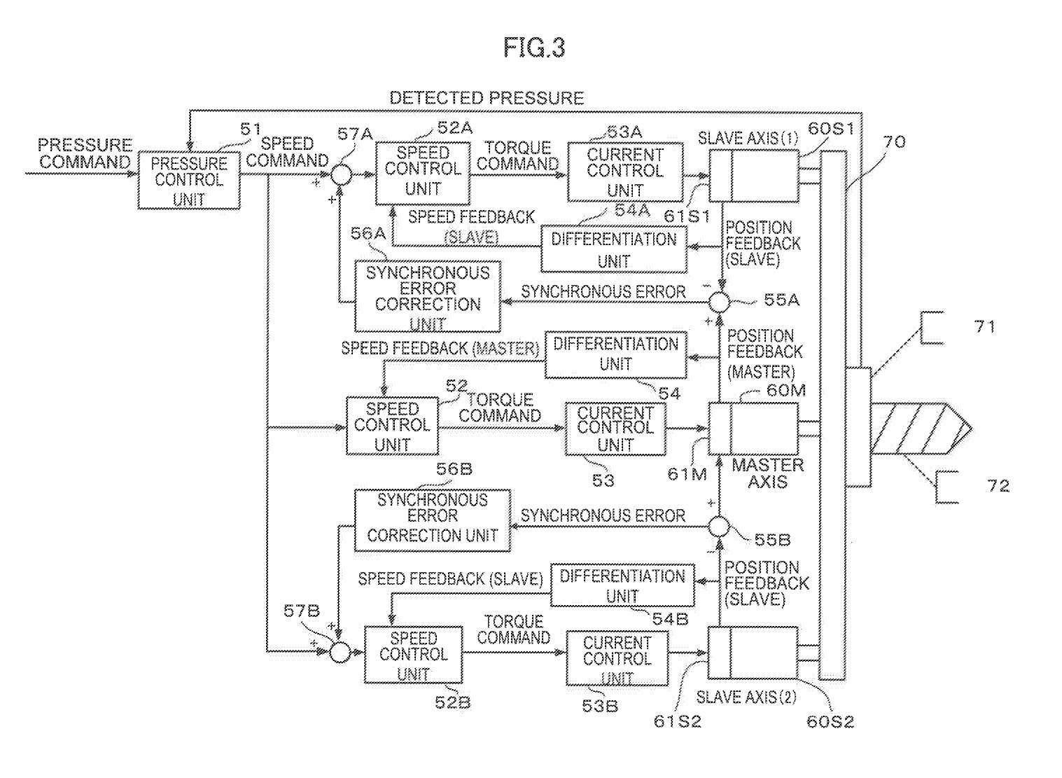

FIG. 3 is a diagram showing an embodiment in which speed commands for three axes are corrected. A controller for controlling motors for a master axis 60M and slave axes 60S1 and 60S2 comprises a pressure control unit 51, speed control units 52, 52A and 52B, current control units 53, 53A and 53B, differentiation units 54, 54A and 54B, synchronous error detection units 55A and 55B, and synchronous error correction units 56A and 56B. The pressure control unit 51 receives a pressure command output from a host control unit. Position sensors 61M, 61S1 and 61S2 for detecting the rotational positions of the motors are built in the motors for the master axis 60M and the slave axes 60S1 and 60S2. The motors for the master axis 60M and the slave axes 60S1 and 60S2 convert rotary drive to linear drive by means of ball screws and nuts, thereby advancing and retracting a slide plate 70.

The pressure control unit 51 calculates a speed command corresponding to a pressure deviation, based on the difference between a pressure command and a pressure detected by the pressure sensor 71, and outputs the calculated speed command to the speed control unit 52 and adders 57A and 57B.

The speed control units 52 and 52A, current control units 53 and 53A, and differentiation units 54 and 54A are constructed in the same manner as those of Embodiment 1.

The speed control unit 52B calculates a torque command corresponding to a speed deviation, based on the difference between a speed command, which is obtained by adding the value output from the pressure control unit 51 and a correction value output from the synchronous error correction unit 56B by the adder 57B, and a speed feedback of the motor for the slave axis 60S2 from the differentiation unit 54B, and outputs the calculated torque command to the current control unit 53B.

The current control unit 53B receives the torque command output from the speed control unit 52B and supplies a current to the motor for the slave axis 60S2 in response to the input torque command.

The differentiation unit 54B differentiates the position feedback from the motor for the slave axis 60S2 and feeds it back as a speed feedback to the speed control unit 52B.

The synchronous error detection unit 55A calculates and outputs, as a synchronous error, the difference between the position feedback from the motor for the master axis 60M and the position feedback from the motor for the slave axis 60S1. The synchronous error output from the synchronous error detection unit 55A is input to the synchronous error correction unit 56A. The synchronous error correction unit 56A calculates a correction amount for a speed command corresponding to the synchronous error input from the synchronous error detection unit 55A and outputs it to the adder 57A.

The synchronous error detection unit 55B calculates and outputs, as a synchronous error, the difference between the position feedback from the motor for the master axis 60M and the position feedback from the motor for the slave axis 60S2. The synchronous error output from the synchronous error detection unit 55B is input to the synchronous error correction unit 56B. The synchronous error correction unit 56B calculates a correction amount for a speed command corresponding to the synchronous error input from the synchronous error detection unit 55B and outputs it to the adder 57B.

### Embodiment 4

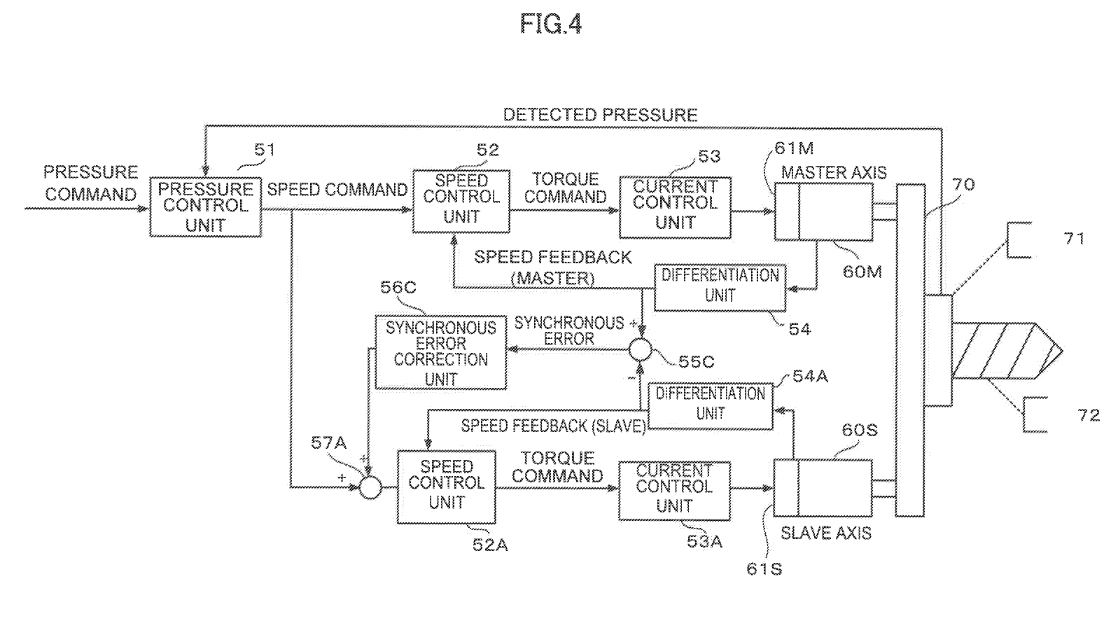

FIG. 4 is a diagram showing an embodiment in which a synchronous error is detected and corrected based on a speed difference in place of the position difference. A controller for controlling motors for a master axis 60M and a slave axis 60S comprises a pressure control unit 51, speed control units 52 and 52A, current control units 53 and 53A, differentiation units 54 and 54A, synchronous error detection unit 55C, and synchronous error correction unit 56C. The pressure control unit 51 receives a pressure command output from a host control unit.

The pressure control unit 51 calculates and outputs a speed command corresponding to a pressure deviation, based on the difference between a pressure command and a pressure detected by the pressure sensor 71.

The speed control unit 52 calculates a torque command corresponding to a speed deviation, based on the difference between the speed command output from the pressure control unit 51 and a speed feedback of the motor for the master axis 60M from the differentiation unit 54, and outputs the calculated torque command to the current control unit 53. The speed control unit 52A calculates a torque command corresponding to the speed deviation, based on the difference between a speed command, which is obtained by adding the value output from the pressure control unit 51 and a correction value output from the synchronous error correction unit 56C by the adder 57A, and a speed feedback of the motor for the slave axis 60S from the differentiation unit 54A, and outputs the calculated torque command to the current control unit 53A.

The current control units 53 and 53A and the differentiation units 54 and 54A are constructed in the same manner as those of Embodiment 1.

The synchronous error detection unit 55C calculates and outputs, as a synchronous error, the difference between a speed feedback as a master, which is obtained by differentiating the position feedback from the motor for the master axis 60M by the differentiation unit 54, and a speed feedback as a slave, which is obtained by differentiating the position feedback from the motor for the master axis 60S by the differentiation unit 54A. The synchronous error output from the synchronous error detection unit 55C is input to the synchronous error correction unit 56C. The synchronous error correction unit 56C calculates a correction amount for a speed command corresponding to the synchronous error input from the synchronous error detection unit 55C and outputs it to the adder 57A.

<Pressure Control Unit>

The pressure control unit calculates a speed command value for an injection axis as a manipulated variable for pressure control, based on a deviation between a pressure command value and a detected pressure value. In injection and dwelling processes, an injection pressure basically varies in proportion to the amount of movement of a screw axis. If the speed command value is calculated as the manipulated variable for pressure control, therefore, the manipulated variable is a speed, and the controlled object is a physical quantity proportional to the position. Thus, the controlled object has an integral characteristic with respect to the manipulated variable, so that the responsiveness of the pressure control can be improved.

<Physical Quantity Control Unit>

The above-described embodiment is also applicable to a case where a physical quantity detection unit configured to detect physical quantities, such as a clamping force, moving platen position, mold opening amount, etc., is provided in place of a pressure detection unit and a plurality of motors are controlled so that the detected physical quantities are equal to set values. In detecting and controlling, for example, the clamping force as a physical quantity, which varies in proportion to the amount of movement of a clamping axis in a mold clamping process, a speed command value is calculated as a manipulated variable for clamping force control. Thereupon, the manipulated variable is a speed, and the controlled object is a physical quantity proportional to the position. Thus, the controlled object has an integral characteristic with respect to the manipulated variable, so that the responsiveness of the clamping force control can be improved. Also in detecting and controlling the moving platen position or mold opening amount as a physical quantity, which varies in proportion to the amount of movement of a mold open/close axis in a mold open/close process, a speed command value is calculated as a manipulated variable for physical quantity control, whereby the responsiveness of the physical quantity control can be improved.

<Synchronous Error Correction Unit>

The synchronous error correction unit calculates a correction amount for the speed command value as a synchronous-error-correction manipulated variable, based on the difference in position or speed between a plurality of injection motors, that is, a synchronous error, thereby correcting the speed command value calculated by the pressure control unit.

The following is a description of a case where the injection screw is driven by two axes, e.g., the master and slave axes. If the positions of the master and slave axes are matched during pressure control, the correction amount for the speed command value calculated based on the synchronous error is added to a speed command value for the slave axis, whereby the speed command value for the slave axis is corrected.

In doing this, only the other speed command value for the slave axis may be corrected without correcting the one speed command value for the master axis (see FIG. 1). Alternatively, correction values of opposite signs may be individually added to the speed command values for the master and slave axes, thereby correcting the speed command values of the axes (see FIG. 2).

If the movement of the slave axis is delayed with respect to that of the master axis, that is, if the position or speed of the slave axis is delayed or reduced with respect to that of the master axis, for example, the speed command value for the slave axis with respect to its advancing direction may be corrected to increase so that the movement of the slave axis advances. Alternatively, a correction may be made such that the speed command value for the slave axis is increased and that the speed command value for the master axis with respect to its advancing direction is reduced so that the movement of the master axis is delayed. In this case, the speed command value is corrected so that the movement of the axis is delayed with respect to its advancing direction. Consequently, the sign of the speed command value may sometimes be inverted so that the direction of the speed command value is opposite to the advancing direction.

<Synchronous Error Detection Unit>

The synchronous error detection unit may be configured to detect the synchronous error based on the difference between the positions of the master and slave axes (see FIGS. 1 to 3) or the difference between the speeds of the axes (see FIG. 4). Alternatively, the synchronous error may be detected based on the difference between the positional deviations between the master and slave axes, that is, deviations between command and actual positions, in place of the positions. If three or more axes are used to drive the driven member, moreover, an average position of all the axes is obtained so that the respective synchronous errors of the axes can be detected based on the differences between the average position and the positions of the axes. Alternatively, the synchronous error of each axis may be detected based on the difference between the position of the axis concerned and the average position of the other axes. Alternatively, furthermore, a single master axis and a plurality of slave axes may be defined so that the synchronous error of each of the slave axes can be detected based on the differences between the positions and speeds of the master axis and the slave axis. Further, the position and speed of each axis may be detected by means of a rotary encoder attached to a motor or a position/speed sensor attached to the driven member.

<Speed Control Unit>

The speed control unit calculates a torque command or a current command as its manipulated variable based on a deviation between the speed command value calculated by the pressure control unit and corrected by the synchronous error correction unit and a detected speed. Since the speed control unit is provided as a subordinate control loop of the pressure control unit, the responsiveness of the detected speed to the speed command value calculated by the pressure control unit can be improved, so that the responsiveness of the pressure control can also be improved. Since the speed control unit is arranged in one-to-one correspondence with each of a plurality of motors, the variation of the detected speed can be reduced despite the variation of the driving torque or frictional resistance between the motors.

The cases of the pressure control unit for controlling the injection pressure and the speed control unit for controlling the speeds of the injection motors have been described in connection with the foregoing embodiment. However, the embodiment is also applicable to a case where a detection unit is provided for detecting the clamping force in place of the injection pressure and a clamping force control unit for controlling the clamping force is used in combination with a speed control unit for controlling the speeds of a plurality of mold clamping motors. Further, the embodiment is applicable to a case where a detection unit is provided for detecting the mold opening amount or moving platen position in place of the injection pressure and a control unit for controlling the mold opening amount or moving platen position is used in combination with the speed control unit for controlling the speeds of the mold clamping motors. According to the embodiment described above, the response characteristics of pressure during the pressure control can be improved, and synchronous errors in position and speed between the axes can be reduced. According to the above-described embodiment, moreover, the response characteristics of physical quantities during the physical quantity control can be improved, and synchronous errors in position and speed between the axes can be reduced.

1. A controller for an injection molding machine, in which one driven member of the injection molding machine is driven by a plurality of axes, the controller comprising:
a physical quantity detection unit configured to detect one of physical quantities including an injection pressure, clamping force, moving platen position, and mold opening amount, which are controlled by the driven member;
a speed command calculation unit configured to calculate a speed command value based on a deviation between the detected physical quantity and a command value;
a synchronous error detection unit configured to detect a synchronous error between the axes;
speed control units arranged in one-to-one correspondence with the axes; and
a synchronous error correction unit configured to correct the speed command value based on the detected synchronous error for each of the axes,
the speed control units being configured to calculate a torque command or a current command based on the corrected speed command value and a detected speed.

2. The controller for an injection molding machine according to claim 1, wherein the synchronous error correction unit is configured to correct speed command values for all the axes including a single master axis or slave axes or all the other axes than the master axis.

3. The controller for an injection molding machine according to claim 1, wherein the synchronous error detection unit is configured to detect the synchronous error based on the difference between the positions of the master axis and the other or slave axes, between an average position of all the axes and the position of each of the axes, or the difference between the position of each of the axes and an average position of all the other axes.

4. The controller for an injection molding machine according to claim 2, wherein the synchronous error detection unit is configured to detect the synchronous error based on the difference between the positions of the master axis and the other or slave axes, between an average position of all the axes and the position of each of the axes, or the difference between the position of each of the axes and an average position of all the other axes.

5. The controller for an injection molding machine according to claim 1, wherein the synchronous error correction unit is configured to increase the speed command value with respect to an advancing direction by correction for that one of the axes whose movement is delayed with respect to that of the other axes and/or reduce the speed command value with respect to the advancing direction by correction for that one of the axes whose movement is advanced with respect to that of the other axes.

6. The controller for an injection molding machine according to claim 1, wherein the driven member is an injection screw, the axes for driving the driven member are injection axes, and the physical quantity is an injection pressure.

7. The controller for an injection molding machine according to claim 5, wherein the driven member is an injection screw, the axes for driving the driven member are injection axes, and the physical quantity is an injection pressure.

8. The controller for an injection molding machine according to claim 1, wherein the driven member is a moving platen, the axes for driving the driven member are clamping axes, and the physical quantity is a clamping force, moving platen position, or mold opening amount.

9. The controller for an injection molding machine according to claim 5, wherein the driven member is a moving platen, the axes for driving the driven member are clamping axes, and the physical quantity is a clamping force, moving platen position, or mold opening amount.
